(19) United States
(12) Patent Application Publication
(10) Pub. No.: US 2007/0258393 A1
(43) Pub. Date: Nov. 8, 2007

(54) System and method for pruning a neighbor list using motion vectors

(75) Inventors: Nancy Cam-Winget, Mountain View, CA (US); Rajneesh Kumar, San Jose, CA (US); Prasad Jogalekar, Sunnyvale, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignee: Cisco Technology, Inc.

(21) Appl. No.: 11/429,751

(22) Filed: May 8, 2006

(51) Int. Cl. H04B 7/00

(52) U.S. Cl. 370/310

(57) ABSTRACT

In one embodiment, a system and method for optimizing a neighbor AP list for a wireless station. The list is optimized based on the current location of the wireless station and the direction of motion. Neighbor APs that are not near the wireless station and/or not in the direction of motion are pruned for the neighbor AP list.

### BACKGROUND OF THE INVENTION

Optimizations to the WLAN infrastructure are evolving to enable fast roaming. Techniques to construct a neighbor list by an infrastructure node (e.g. access points (APs) or controllers) are being used to further facilitate roaming by either providing the neighbor list information to a wireless station (client) directly, or to pre-provision resources and other required context to APs prior to a station's roaming to that AP. However, the neighbor lists tend to be over inclusive. The lists frequently include APs that a wireless station will probably not roam.

### OVERVIEW OF EXAMPLE EMBODIMENTS

In accordance with an aspect of the present invention, there is disclosed herein a means for optimizing a neighbor list based on a client's direction of motion.

In accordance with an aspect of the present invention, there is disclosed herein a method for generating an optimized list of neighboring access points for a wireless station. The method comprises determining the direction of motion for the wireless station. A list of neighboring access points for the wireless station is generated based on the location and the direction of motion of the wireless station.

In accordance with an aspect of the present invention, there is disclosed herein an apparatus for producing an optimized neighbor list. The apparatus comprising a communications interface for receiving signals from a plurality of access points containing data indicative of a signal sent by a wireless station and neighbor list logic coupled to the communications interface and configured to process the signals from the plurality of access points. The neighbor list logic is responsive to determine a direction of motion for the wireless station based on the signals received from the plurality of access points. Furthermore, the neighbor list logic is responsive to determining the direction of motion to generate a list of neighboring access points for the wireless station.

In accordance with an aspect of the present invention, there is disclosed herein an apparatus comprising means for determining a direction of motion for the wireless station. The apparatus also comprises means for generating a list of neighboring access points for the wireless station based on the direction of motion.

Still other objects of the present invention will become readily apparent to those skilled in this art from the following description wherein there is shown and described a preferred embodiment of this invention, simply by way of illustration of at least one of the best modes best suited to carry out the invention. As it will be realized, the invention is capable of other different embodiments and its several details are capable of modifications in various obvious aspects all without departing from the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrates several aspects of the present invention, and together with the description serve to explain the principles of the invention.

FIG. 1 is a block diagram of an exemplary system implementing an aspect of the present invention.

FIG. 2 is a diagram illustrating the hierarchical relationship between infrastructure nodes of the network illustrated in FIG. 1.

FIG. 3 is a detailed block diagram of system components illustrated in FIGS. 1 and 2.

FIG. 4 is a block diagram of a computer system for implementing an aspect of the present invention.

FIG. 5 is a block diagram of a methodology of the present invention.

### DESCRIPTION OF EXAMPLE EMBODIMENTS

Throughout this description, the preferred embodiment and examples shown should be considered as exemplars, rather than limitations, of the present invention. An aspect of the present invention is to optimize (prune) a neighbor access point (AP) list in a wireless local area network (WLAN) in order to allocate resources on APs that are in the general direction of where the wireless station (STA or client) is roaming, as opposed to allocating resources to all neighboring APs, and/or for signaling to the STA the optimized list of neighbors. The pruning can be performed by any means that can provide direction of motion. For example, RSSI trending analysis can be used to determine the general direction the wireless station is heading. The techniques described herein can also be utilized to prune a neighbor list for aiding directed roaming.

An aspect of the present invention as described herein utilizes a module (which can be implemented in hardware, software or a combination thereof) for optimizing the neighbor list, those skilled in the art can readily appreciate that the present invention does not require a separate location services server (LSS) to be present on the network. The aspects of the present invention can be co-located and implemented in any of the various network infrastructure nodes such as an AP, AAA (Authentication, Authorization and Accounting) server, controller, location server (LSS), etc.

In a preferred embodiment, direction determination uses RSSIs (Received Signal Strength Intensities) sampled by (typically three or more) access points, typically on the same channel as the client. The sampled information may be sent to another node in the network such as the controller or a location server that will participate in narrowing down the list of APs towards which the STA is moving.

In accordance with an aspect of the present invention, trending/gradient analysis of the RSSI (received signal strength intensity) is performed and can be used to determine the expected direction of movement for a wireless station (mobile client). The expected direction of movement thus concluded is correlated with the access point coordinates to determine the client's predicted movement path. The access point co-ordinates and the relative co-ordinates of neighboring APs to which the client is currently associated could be available from a centralized node such as the WLSE or a Location Server.

For indoor as well as outdoor motion tracking, established RSSI-filtering/sampling criteria (e.g. specified percentile value measured over a specified time interval, typically a few seconds, and then maintained as moving average for analysis) can be used. For example, a 50 percentile of the RSSI values obtained for a client per 3 second interval suffices for most indoor mobility requirements. Sampling rate can even be made adaptive based on estimated errors in RSSI measurements automatically, or it can be tuned by the administrator depending on the wireless devices mobility requirements.

In a preferred embodiment, RSSI samples obtained every 3 seconds result in acceptable amount of lag, so that the analysis is actually useful before the client moves close to the neighboring APs, for example about 60 feet away. (On the average, 60 feet separation gives 6-7 sample periods if the client moves at roughly 3 feet/sec, sufficient for gradient/trending analysis, and pre-provisioning the neighboring APs. Fewer samples can work too, but higher sampling rate would typically result in higher accuracy. An aspect of the present invention is that it is not constrained by any new or existing specific RSSI filtering/sampling algorithms

In a preferred embodiment, any three APs (not necessarily adjacent) have to hear a client for triangulation to work. A client has to send out at least one packet (e.g. an Institute of Electrical and Electronics Engineers “IEEE” 802.11 packet). Whether the packet is a control packet or a data packet does not matter, as long as it results in an RSSI reading at the receiver AP. Preferably a packet is sent at least every 3 seconds (or whatever sampling period is used). If more than 3 APs receive the client's packet, it usually results in better accuracy of client's location estimate, and hence, further improves predictions referred to in this application.

Aspects of the present invention are suitable for transportation or public safety environments where clients are expected to be in constant motion for a set period of time. Thus determining the direction vector of motion can further help the network infrastructure proactively provision or pre-allocate resources (e.g. keys and admission capacity). In heavily used environments, it can also be used to favorably balance the load on the network infrastructure.

When pre-provisioning the pruned list of APs to a client, benefits to the client include but are not limited to a refinement of the set of neighbors it considers as candidates and thus minimizes the potential off-channel chatter or wired pre-reservations.

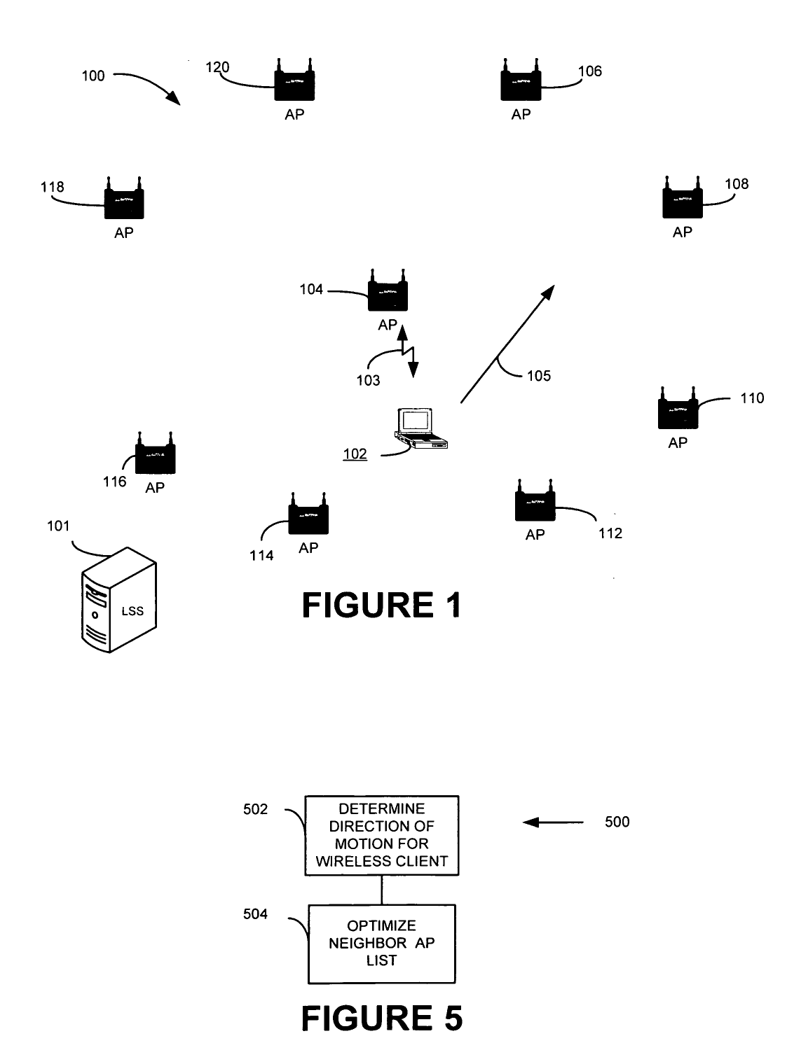

FIG. 1 is a block diagram of an exemplary system 100 implementing an aspect of the present invention. The system shows a wireless station (mobile client) 102 wirelessly communicating via path 103 to AP 104. In the example illustrated in FIG. 1, wireless station 102 is traveling in direction 105. APs 106 108 110 112 114 116 118 120 are neighboring APs to AP 104. A module, the Location Services Server (LSS) 101, is communicatively coupled to APs 104 106 108 110 112 114 116 118 120.

LSS 101 is configured with logic for providing location services for network 100. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software. LSS 101 is suitably adapted to receive signals from APs 104 106 108 110 112 114 116 118 120 as appropriate for determining the location and direction of a wireless station, such as wireless station 102, traveling in direction 105.

In accordance with an aspect of the present invention, APs from the group of APs 104, 106, 108, 110, 112, 114, 116, 118 and 120 that receive a signal from wireless client 102, send a signal to LSS 101. In a preferred embodiment, the signal sent to LSS 101 contains data representative of MAC address, signature, RSSI and/or Angle of Arrival (AOA) of the signal sent from wireless station 102. LSS 101 determines the location of wireless client 102 based on the RSSI data obtained from the APs from the group of APs 104, 106, 108, 110, 112, 114, 116, 118 and 120 that received a signal from wireless client 102. In a preferred embodiment, LSS 101 contains, or is coupled to, a memory for storing location data and/or data representative of the RSSI received for wireless station 102. Logic in LSS 101 employs the stored data for wireless station to determine the direction 105 that wireless station 102 is heading.

In accordance with an aspect of the present invention, LSS 101 generates an optimized neighbor list for wireless client 102 based on the location of wireless client 102 and direction 105 of travel. In accordance with a preferred embodiment, LSS 101 stores location data for wireless station 102 and can trend the direction 105 of wireless station 102 by comparing the current location with the stored results. In accordance with another preferred embodiment, LSS 101 can store RSSI information received from one or more of AP's 104, 106, 108, 110, 112, 114, 116, 118 and 120 and determine the direction wireless station 102 is moving based on trending the RSSI data for determining which APs have increasing RSSI and/or which APs have decreasing RSSI.

For example, FIG. 1 shows wireless station 102 associated with AP 104. LSS 101 would know that APs 106, 108, 110, 112, 114, 116, 118 and 120 are neighboring APs of AP 104. Therefore, a neighbor list could comprise APs 106, 108, 110, 112, 114, 116, 118 and 120. However, because LSS 101 can determine that wireless station 102 is traveling in direction 105 and can prune the neighbor AP list by removing APs opposite direction 105, which in this example could include APs 114 and 116. As used herein, opposite can be defined as an AP that is more than approximately 90 degrees from direction 105, or any other desired angle. As used herein, approximately is defined to be within 20% of a given value. Thus, for example, APs 112 and 118 may also be pruned from the neighbor AP list, leaving an optimized neighbor AP list of APs 106, 108, 110 and 120. However, because both distance and direction 105 of travel are factors in generating the neighbor AP list, AP 112 may still be included on the list because of its close proximity to wireless station 102. As those skilled in the art can readily appreciate, the parameters for distance and direction can be varied to any desired realizable range.

In accordance with an aspect of the present invention, LSS 101 can be configured to throttle generating the neighbor list until a predetermined threshold is met. For example, while wireless station 102 is close to AP 104, or is not moving, LSS 101 can throttle neighbor list generation. Once it is determined that wireless station 102 is moving, or the RSSI detected by AP 104 falls below a predetermined threshold, LSS 101 initiates neighbor list generation.

In accordance with an aspect of the present invention, LSS 101 can be configured to initiate a roam when a predetermined threshold is met. For example, if LSS 101 determines that the RSSI for AP 104 is below a predetermined threshold, LSS 101 can initiate a roam by wireless station 102. Optionally, LSS 101 can also be configured to direct the roam. For example, LSS 101 can direct wireless station 102 to roam to the AP with the highest RSSI for wireless station 102.

In accordance with an aspect of the present invention, LSS 101 can be configured to determine the velocity of wireless station 102 and respond accordingly. For example, in a preferred embodiment LSS 101 receives signals from neighboring APs that are receiving a signal from wireless station 102 before the expiration of a predetermined time period, e.g. 3 seconds. Each time APs 106, 108, 110, 112, 114, 116, 118 and/or 120 receives signal a signal from wireless station 102, the APs receiving the signal send data to LSS 101 representative of RSSI of the signal received from wireless station 102. LSS 101 can compute the current location of wireless station 102 and compare it with prior locations to determine the velocity of wireless station 102 (LSS 101 would also note the time elapsed between signals to perform this function). In a preferred embodiment, if LSS 101 determines that the velocity of wireless station 102 exceeds a predetermined velocity, LSS 101 can decrease the time period for determining the location and direction 105 for wireless station 102 (i.e. increase the sample rate). Similarly, if LSS 101 determines that the velocity of wireless station 102 is less than a predetermined velocity, LSS 101 can increase the time period for determining the location and direction 105 for wireless station 102 (i.e. decrease the sample rate). For example, initially LSS 101 can determine the location and direction 105 for wireless station 102 every 3 seconds, and adjust the time for determining location and direction 105 upward or downward depending on the velocity of wireless station 102.

In accordance with an aspect of the present invention, LSS 101 can be configured to be responsive to changes in direction 105 for wireless station 102 to update the optimized neighbor list. Because LSS 101 receives updated data for wireless station 102, LSS 101 can compute new location, direction 105 and/or velocity data for wireless station 102. If LSS 101 determines wireless station 102 has changed direction of movement, the neighbor list can be updated accordingly. For example, if wireless station 102 is moving in a direction opposite to direction 105, the neighbor AP list can be re-optimized to APs 112, 114, 116 and 118 and APs 106, 108, 110 and 120 can be pruned from the list.

In accordance with an aspect of the present invention, LSS 101, or any module or infrastructure node implementing the functionality described herein for LSS 101, such as a mobility context manager, can be configured to provision resources on APs on the optimized neighboring access point list. For example, LSS 101 can send one or more of quality of service (QoS) parameters, fault tolerance, accounting data, configuration data and keying data for the wireless station for wireless station 102 to APs on the optimized neighboring access point list. A benefit of this aspect is that it can facilitate faster roaming for wireless station 102. Alternatively, or optionally, LSS 101 can communicate with AP 104 to have a packet send to wireless station 102 containing the list of neighboring access points.

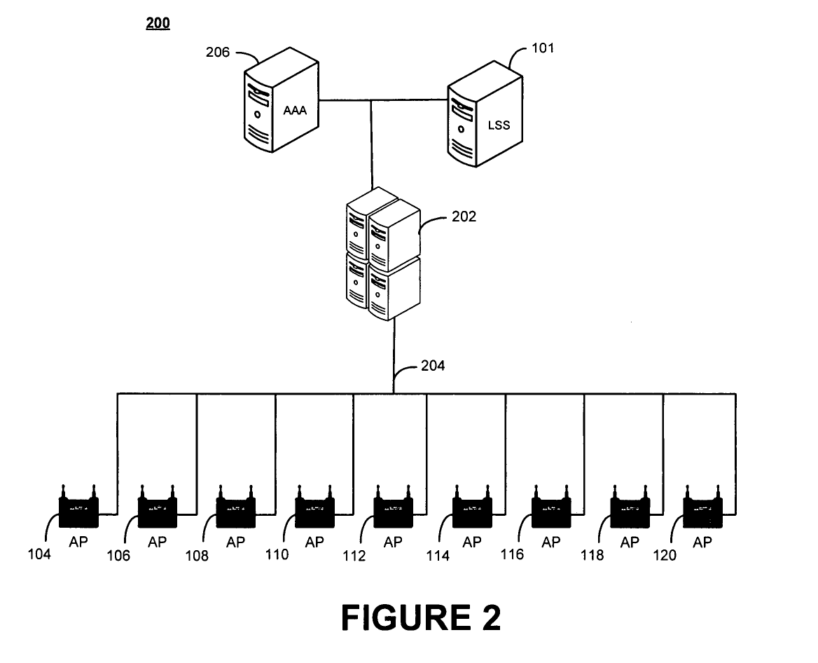

FIG. 2 is a logical hierarchical diagram 200 illustrating the logical relationship between infrastructure nodes of the network illustrated in FIG. 1. APs 104, 106, 108 110, 112, 114 116 118 and 120 are coupled to controller 202 via a distribution network 204. Network 204 may suitably comprise one or more wired and/or wireless segments. Controller 202 is employed to control the operation of APs 104, 106, 108 110, 112, 114 116 118 and 120. As illustrated, an AAA server 206 and LSS 101 are coupled to controller 202. In alternative embodiments (not shown) AAA server 206 and LSS 101 can also be coupled to controller 202 via network 204, as the logical hierarchy of the network is not necessarily the same as the physical connectivity.

Furthermore, it is also contemplated that the functionality of LSS 101 does not necessarily have to be performed by a standalone network component. For example, the logic for performing the functionality of LSS 101 can be co-located with AAA server 206, controller 202 or any one of APs 104, 106, 108 110, 112, 114 116 118 and 120.

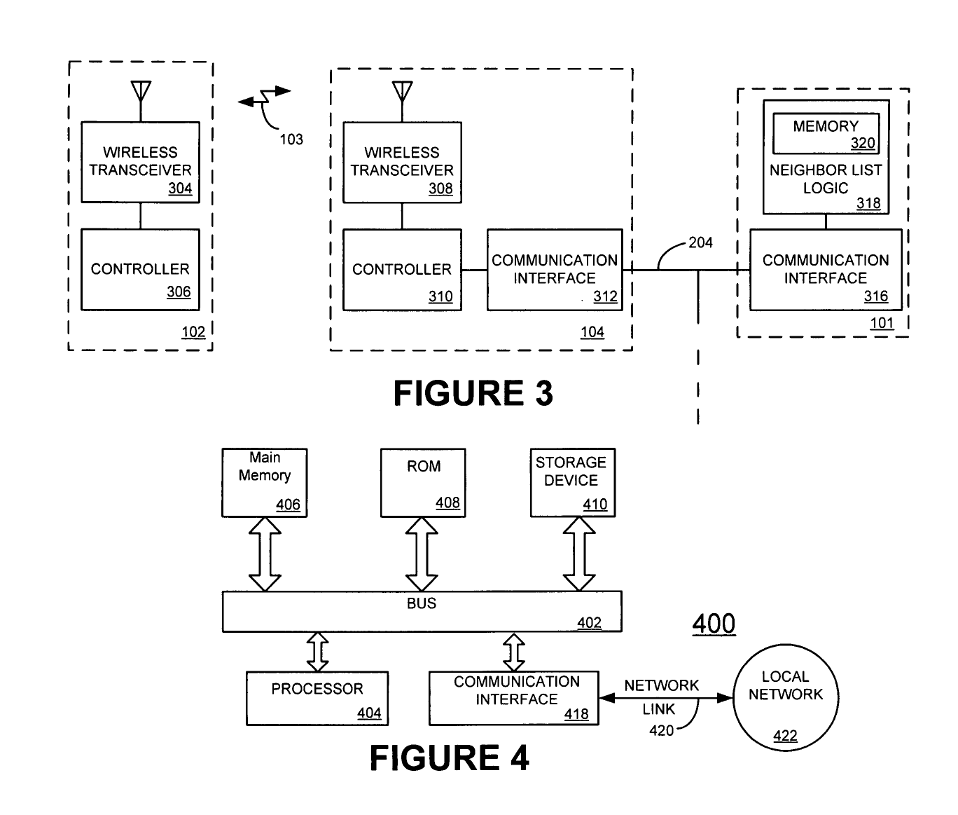

FIG. 3 is a detailed block diagram 300 of system components illustrated in FIGS. 1 and 2. Wireless station 102 comprises a wireless transceiver 304 and controller 306. Wireless transceiver performs signal processing of wireless signals sent and received by wireless station 102 and suitably comprises an antenna sending and receiving wireless signals, amplifiers , filters, frequency converters (e.g. Radio Frequency “RF” to Baseband “BB” or Intermediate Frequencies “IF” digital to analog (D/A) and analog to digital (A/D) converts as needed. If wireless station 102 is an 802.11 compatible, wireless transceiver 304 may further comprise Physical Layer (PHY) and Media Access Layer (MAC) processors.

Controller 306 controls the operation of wireless transceiver 304. For example controller 306 can control the output power, operating frequencies or initiate roaming. Controller 306 may also processes signals processed (sent or received) by wireless transceiver 304.

AP 104 suitably comprises a wireless transceiver 308, controller 310 and a communication interface 312. It should also be understood that APs 106, 108, 110, 112, 114, 116, 118 and 120 may also be similarly configured.

Wireless transceiver performs signal processing of wireless signals sent and received by wireless station 102 and suitably comprises an antenna sending and receiving wireless signals, amplifiers, filters, frequency converters (e.g. Radio Frequency “RF” to Baseband “BB” or Intermediate Frequencies “IF” digital to analog (D/A) and analog to digital (A/D) converts as needed. If wireless station 102 is an 802.11 compatible, wireless transceiver 308 may further comprise Physical Layer (PHY) and Media Access Layer (MAC) processors.

Controller 310 controls the operation of wireless transceiver 308. For example controller 310 can control the output power, operating frequencies or initiate roaming. Controller 310 may also processes signals processed (sent or received) by wireless transceiver 308.

Communication interface 312 is coupled to controller 310. Communication interface 310 is employed to communicate with LSS 101. Communication between communication interface 312 and LSS 101 occurs over distribution network 204. Additional infrastructure nodes (not shown) such as additional APs, controllers and servers can also be coupled to distribution network 204. FIG. 3 merely shows a single wireless station 102, AP 104 and LSS 101 for ease of illustration and should not be construed to be limited to only one wireless station, AP or LSS as any reasonable number of these components can be employed.

LSS 101 suitably comprises a communication interface 316 that is coupled to neighbor list logic 318. Communication interface 318 is configured to exchange signals between LSS 101 and AP 104 and other infrastructure nodes (not shown). In a preferred embodiment, communication interface 318 is receiving signals for a wireless station, such as wireless station 102, from at least 3 APs. As is described herein, neighbor list logic 318 is configured to process the data received from APs to optimize (prune) a neighbor AP list.

In accordance with an aspect of the present invention, in operation, wireless transceiver 308 is responsive to receiving a wireless signal, such as a packet, wireless station 102 (sent by wireless transceiver 304) to forward data representative of the signal (packet) and/or signal properties (such as RSSI MAC Address, Signature, and possibly Angle of Arrival “AOA”) to controller 310. Controller 310 forwards the appropriate data received or derived from wireless transceiver 308 to LSS 101 via communication interface 312 over distribution network 204. LSS 101 receives the data from AP 104 via communication interface 316. Communication interface 316 forwards the data to neighbor list logic 318, which then processes the data and generates an optimized (pruned) neighbor list as described herein.

In a preferred embodiment, the data sent to neighbor list logic 318 contains data representative of MAC address, signature and/or RSSI of the signal 103 sent from wireless station 102. Neighbor list logic 318 determines the location of wireless client 102 based on the RSSI data obtained from the APs from the group of APs 104, 106, 108, 110, 112, 114, 116, 118 and 120 that received a signal from wireless client 102. In a preferred embodiment, neighbor list logic 318 contains, or is coupled to, a memory for storing location data and/or data representative of the RSSI received for wireless station 102. Logic in neighbor list logic 318 employs the stored data for wireless station to determine the direction 105 that wireless station 102 is heading.

In accordance with an aspect of the present invention, neighbor list logic 318 generates an optimized neighbor list for wireless client 102 based on the location of wireless client 102 and direction 105 of travel. In accordance with a preferred embodiment, neighbor list logic 318 stores location data for wireless station 102 and can trend the direction 105 of wireless station 102 by comparing the current location with the stored results. In accordance with another preferred embodiment, neighbor list logic 318 can store RSSI information received from one or more of AP's 104, 106, 108, 110, 112, 114, 116, 118 and 120 and determine the direction wireless station 102 is moving based on trending the RSSI data for determining which APs have increasing RSSI and/or which APs have decreasing RSSI.

For example, FIG. 1 shows wireless station 102 associated with AP 104. neighbor list logic 318 would know that APs 106, 108, 110, 112, 114, 116, 118 and 120 are neighboring APs of AP 104. Therefore, a neighbor list could comprise APs 106, 108, 110, 112, 114, 116, 118 and 120. However, because neighbor list logic 318 can determine that wireless station 102 is traveling in direction 105 and can prune the neighbor AP list by removing APs opposite direction 105, which in this example could include APs 114 and 116. As used herein, opposite can be defined as an AP that is more than approximately 90 degrees from direction 105, or any other desired angle. As used herein, approximately is defined to be within 20% of a given value. Thus, for example, APs 112 and 118 may also be pruned from the neighbor AP list, leaving an optimized neighbor AP list of APs 106, 108, 110 and 120. However, because both distance and direction 105 of travel are factors in generating the neighbor AP list, AP 112 may still be included on the list because of its close proximity to wireless station 102. As those skilled in the art can readily appreciate, the parameters for distance and direction can be varied to any desired realizable range.

In accordance with an aspect of the present invention, neighbor list logic 318 can be configured to throttle generating the neighbor list until a predetermined threshold is met. For example, while wireless station 102 is close to AP 104, or is not moving, neighbor list logic 318 can signal AP 104 via communication interface 316 to throttle neighbor list generation. Once it is determined wireless station 102 is moving, or the RSSI detected by AP 104 falls below a predetermined threshold, neighbor list logic 318 initiates neighbor list generation.

In accordance with an aspect of the present invention, neighbor list logic 318 can be configured to initiate a roam when a predetermined threshold is met. For example, if neighbor list logic 318 determines that the RSSI for AP 104 is below a predetermined threshold, neighbor list logic 318 can initiate a roam by wireless station 102. Optionally, neighbor list logic 318 can also be configured to direct the roam. For example, neighbor list logic 318 can direct wireless station 102 to roam to the AP with the highest RSSI for wireless station 102.

In accordance with an aspect of the present invention, neighbor list logic 318 can be configured to determine the velocity of wireless station 102 and respond accordingly. For example, in a preferred embodiment neighbor list logic 318 receives signals from neighboring APs that are receiving a signal from wireless station 102 before the expiration of a predetermined time period, e.g. 3 seconds. Each time APs 106, 108, 110, 112, 114, 116, 118 and/or 120 receives signal a signal from wireless station 102, the APs receiving the signal send data to neighbor list logic 318 representative of RSSI of the signal received from wireless station 102. neighbor list logic 318 can compute the current location of wireless station 102 and compare it with prior locations to determine the velocity of wireless station 102 (neighbor list logic 318 would also note the time elapsed between signals to perform this function).

In a preferred embodiment, if neighbor list logic 318 determines that the velocity of wireless station 102 exceeds a predetermined velocity, neighbor list logic 318 can decrease the time period for determining the location and direction 105 for wireless station 102 (i.e. increase the sample rate). Similarly, if neighbor list logic 318 determines that the velocity of wireless station 102 is less than a predetermined velocity, neighbor list logic 318 can increase the time period for determining the location and direction 105 for wireless station 102 (i.e. decrease the sample rate). For example, initially neighbor list logic 318 can determine the location and direction 105 for wireless station 102 every 3 seconds, and adjust the time for determining location and direction 105 upward or downward depending on the velocity of wireless station 102.

In accordance with an aspect of the present invention, neighbor list logic 318 can be configured to be responsive to changes in direction 105 for wireless station 102 to update the optimized neighbor list. Because neighbor list logic 318 receives updated data for wireless station 102, neighbor list logic 318 can compute new location, direction 105 and/or velocity data for wireless station 102. If neighbor list logic 318 determines wireless station 102 has changed direction of movement, the neighbor list can be updated accordingly. For example, if wireless station 102 is moving in a direction opposite to direction 105, the neighbor AP list can be re-optimized to APs 112, 114, 116 and 118 and APs 106, 108, 110 and 120 can be pruned from the list.

In accordance with an aspect of the present invention, neighbor list logic 318 can validate wireless station 102 when determining location and direction 105. For example, referring to FIG. 1 with continued reference to FIG. 3, APs 104, 106, 108, 110, 112, 114, 116, 118 and 120 can be configured to send the MAC address and a signature (which in a preferred embodiment is encrypted) received from wireless station 102. When APs 104, 106, 108, 110, 112, 114, 116, 118 and 120 send data to neighbor list logic 318 (such as RSSI data for wireless station 102), they would also send the MAC address and signature. Neighbor list logic 318 can decrypt and verify that the signature is appropriate for the MAC address.

For example, a transmission by wireless station 102 can be used as an event to trigger RSSI trending analysis by neighbor list logic 318. Every AP that receives a packet from wireless station 102 conveys the MAC address and signature of the received packet to neighbor list logic 318. The signature can be a CRC for the packet, or a predetermined hash function computed for the packet. If a predetermined hash function is computed, the APs receiving the packet should perform the same hash function.

In accordance with an aspect of the present invention, neighbor list logic 318 can be configured to provision resources on APs on the optimized neighboring access point list. For example, neighbor list logic 318 can send one or more of quality of service (QoS) parameters, fault tolerance, accounting data, configuration data and keying data for the wireless station for wireless station 102 to APs on the optimized neighboring access point list. A benefit of this aspect is that it can facilitate faster roaming for wireless station 102. Alternatively, or optionally, neighbor list logic 318 can communicate with AP 104 to have a packet send to wireless station 102 containing the list of neighboring access points.

FIG. 4 is a block diagram of a computer system 400 for implementing an aspect of the present invention. Computer system 400 is suitably adapted to be employed for performing the functionality of neighbor list logic 318 (FIG. 3), controller 310 (FIG. 3) and/or controller 306 (FIG. 3).

Computer system 400 includes a bus 402 or other communication mechanism for communicating information and a processor 404 coupled with bus 402 for processing information. Computer system 400 also includes a main memory 406, such as random access memory (RAM) or other dynamic storage device coupled to bus 402 for storing information and instructions to be executed by processor 404. Main memory 406 also may be used for storing a temporary variable or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

An aspect of the invention is related to the use of computer system 400 for pruning a neighbor list using location and motion vectors for proactive resource allocation. According to one embodiment of the invention, pruning a neighbor list using location and motion vectors for proactive resource allocation is provided by computer system 400 in response to processor 404 executing one or more sequences of one or more instructions contained in main memory 406. Such instructions may be read into main memory 406 from another computer-readable medium, such as storage device 410. Execution of the sequence of instructions contained in main memory 406 causes processor 404 to perform the process steps described herein. One or more processors in a multi-processing arrangement may also be employed to execute the sequences of instructions contained in main memory 406. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 404 for execution. Such a medium may take many forms, including but not limited to non-volatile media, volatile media, and transmission media. Non-volatile media include for example optical or magnetic disks, such as storage device 410. Volatile media include dynamic memory such as main memory 406. Transmission media include coaxial cables, copper wire and fiber optics, including the wires that comprise bus 402. Transmission media can also take the form of acoustic or light waves such as those generated during radio frequency (RF) and infrared (IR) data communications. Common forms of computer-readable media include for example floppy disk, a flexible disk, hard disk, magnetic cards, paper tape, any other physical medium with patterns of holes, a RAM, a PROM, an EPROM, a FLASHPROM, any other memory chip or cartridge, a carrier wave as described hereinafter, or any other medium from which a computer can read.

Various forms of computer-readable media may be involved in carrying one or more sequences of one or more instructions to processor 404 for execution. For example, the instructions may initially be borne on a magnetic disk of a remote computer. The remote computer can load the instructions into its dynamic memory and send the instructions over a telephone line using a modem. A modem local to computer system 400 can receive the data on the telephone line and use an infrared transmitter to convert the data to an infrared signal. An infrared detector coupled to bus 402 can receive the data carried in the infrared signal and place the data on bus 402. Bus 402 carries the data to main memory 406 from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic, or optical signals that carry digital data streams representing various types of information. Network link 420 typically provides data communication through one or more networks to other data devices.

In view of the foregoing structural and functional features described above, a methodology in accordance with various aspects of the present invention will be better appreciated with reference to FIG. 5. While, for purposes of simplicity of explanation, the methodology of FIG. 5 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention. Embodiments of the present invention are suitably adapted to implement the methodology in hardware, software, or a combination thereof.

FIG. 5 is a block diagram of a methodology 500 in accordance with an aspect of the present invention. Methodology 500 is suitably adapted for pruning a neighbor list using location and motion vectors for proactive resource allocation.

At 502, the direction of motion for a wireless station is determined. For example, the direction can be determined by comparing past and current location coordinates or by comparing past and current RSSI values for APs receiving the wireless station.

At 504, an optimized neighbor list is determined for the wireless station. The neighbor list suitably comprises neighboring APs that are in the direction that the wireless station is traveling and thus more likely for the wireless station to roam. For example, a neighbor AP list can include all neighboring APs to the AP which the wireless station is currently associated or attached. An aspect of the present invention is that the list is then pruned based on the wireless station's direction of motion determined at 504. APs that are either far away from the wireless station and/or not in the direction of travel for the wireless station are then pruned from the neighbor AP list.

In accordance with an aspect of the present invention, steps 502 and 504 can be repeated before a predetermined time period expires. Each time APs receive a signal from the wireless station, the current location and direction of travel for the wireless station is again computed. If either the location or direction of travel have changed, the optimized list can be updated by either pruning additional APs that are not in the newly computed direction and/or APs that are now in the direction of travel that were not previously on the neighbor AP list can be added. In a preferred embodiment, the predetermined time period is approximately three seconds. However, this time period can be varied as desired, such as increased if the wireless station is moving at a fast rate or decreased if the wireless station is moving at a slow rate. The currently velocity of the wireless station can be computed to determine whether the predetermined time period can be changed. The velocity can be computed by determining the change of location over time or by changes of measured RSSI over time. In a preferred embodiment, the RSSI is received by APs that are at fixed locations.

An aspect of methodology 500 is that the direction of the wireless station determined at 502 can be determined by trending the RSSI of signals transmitted by the wireless stations. The signals from the wireless station are received by a plurality, preferably at least three, APs at known or fixed locations. The direction of travel is determined by trending RSSI values over time. For example, the direction can be determined by ascertaining which APs are showing an increase in RSSI and/or which APs are showing a decrease in RSSI for the wireless station. Furthermore, the rate of change in RSSI can also be used to determined velocity.

In accordance with an aspect of the present invention, a MAC address and signature received form the wireless station can be utilized to verify the identity of the wireless station. The signature can be verified to ascertain that it corresponds to the MAC address. In a preferred embodiment, the signature is encrypted, thus the signature is decrypted and then compared with the MAC address to verify the signature corresponds to the MAC address.

In accordance with an aspect of the present invention, methodology 500 can throttle itself responsive to determining the RSSI at a predetermined location falling below a predetermined threshold. For example, as long as the RSSI remains above a predetermined threshold for the AP that the wireless station is currently associated, methodology 500 will throttle itself. However, if the RSSI goes below the predetermined threshold, methodology 500 is responsive to initiate execution, i.e. determine location and direction of motion to optimize the neighbor list.

In accordance with an aspect of the present invention, a resource can be provisioned to a neighboring access points on the optimized (pruned) list. For example, resources such as quality of service (QoS) parameters, fault tolerance, accounting data, configuration data and keying data for the wireless station can be provisioned to a neighbor AP on the optimized neighbor AP list. Because the list is optimized based on location and direction, APs that are potential APs for the wireless station to roam are provisioned. Alternatively, or optionally, the optimized list can be sent to the wireless station.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims interpreted in accordance with the breadth to which they are fairly, legally and equitably entitled.

1. A method for generating a list of neighboring access points, the method comprising:
determining a location and a direction of motion of a wireless station; and
based on the location and the direction of motion of the wireless station, generating a list of access points neighboring the wireless station.

2. A method according to claim 1, further comprising:
determining a second location and a second direction of motion for the wireless station a second time after a predetermined time period expires; and
based on the second location and the second direction of motion for the wireless station at the second time, updating the list.

3. A method according to claim 2, further comprising:
determining a velocity for the wireless station;
wherein the predetermined time period is increased responsive to determining the velocity is below a predetermined threshold.

4. A method according to claim 2, further comprising:
determining a velocity for the wireless station;
wherein the predetermined time period is decreased responsive to determining the velocity is above a predetermined threshold.

5. A method according to claim 1, wherein determining the location is based on received signal strength intensity (RSSI) of a signal transmitted by the wireless station that is received at a plurality of fixed locations.

6. A method according to claim 1, wherein determining the direction of motion for the wireless station is based on received signal strength intensity (RSSI) trending of signals transmitted by the wireless station that is received at a plurality of fixed locations.

7. A method according to claim 6, wherein determining the direction of motion is responsive to trending signals determining a fixed location where the RSSI is increasing.

8. A method according to claim 7, wherein determining the direction of the wireless station is responsive to trending of signals determining a second fixed location where the RSSI is decreasing.

9. A method according to claim 1, further comprising determining a location of the wireless station and determining the direction of motion for the wireless station responsive to a received signal strength intensity at a predetermined location falling below a predetermined threshold.

10. A method according to claim 1, further comprising provisioning a resource to the neighboring access points on the list.

11. A method according to claim 10, further comprising determining a velocity for the wireless station, wherein the provisioning a resource is based on the direction of motion and the velocity of the wireless client.

12. A method according to claim 10, the resource is selected from a group consisting of quality of service (QoS) parameters for the wireless station, fault tolerance for the wireless station, accounting data for the wireless station, configuration data for the wireless station and keying data for the wireless station.

13. A method according to claim 1, further comprising transmitting the list to the wireless station.

14. An apparatus for producing an optimized neighbor list, comprising:
a communications interface for receiving signals from a plurality of access points containing data indicative of a signal sent by a wireless station; and
neighbor list logic coupled to the communications interface and configured to process the signals from the plurality of access points;
wherein the neighbor list logic based on the signals received from the plurality of access points is responsive to determine a direction of motion for the wireless station; and
wherein the neighbor list logic is responsive to generate a list of neighboring access points for the wireless station based on the direction of motion.

15. An apparatus according to claim 14, wherein the data indicative of the signal sent by the wireless signal comprises received signal strength intensity (RSSI).

16. An apparatus according to claim 15, wherein the neighbor list logic is configured to determine the direction of motion based on trending RSSI of signals transmitted by the wireless station received by the plurality of access points.

17. An apparatus according to claim 16, wherein the neighbor list logic is configured to determine the direction of motion responsive to trending one of a group consisting of access points of the plurality of access points for which the RSSI is increasing and access points of the plurality of access points for which the RSSI is decreasing.

18. An apparatus according to claim 14, wherein the neighbor list logic configured to optimize the list of neighboring access points by removing an access point from the list that is not in the direction of motion.

19. An apparatus according to claim 14, wherein the neighbor list logic is configured to initiate one of a group consisting of determining a second location of the wireless station, determining a second direction of motion and generating a second list of neighboring access points responsive to a received signal strength at a one of the plurality of access points being below a predetermined threshold.

20. An apparatus according to claim 14, wherein the neighbor list logic is responsive to receiving second signals from the plurality of access points containing data indicative of a second signal sent by the wireless station to determine a second location for the wireless station based on the second signals, to determine a new direction of motion for the wireless station based on the second signals and generating a second list based on the second location and the second direction of motion.

21. An apparatus according to claim 14, wherein the neighbor list logic is configured to determine a velocity for the wireless station based on the signals received form the plurality of access points.

22. An apparatus, comprising:
means for determining a direction of motion for the wireless station; and
means for generating a list of neighboring access points for the wireless station based on the location and the direction of motion.

23. An apparatus according to claim 22, further comprising:
means for determining a velocity for the wireless station based on the location and direction of motion.
